(19) United States
(12) Patent Application Publication
(10) Pub. No.: US 2023/0064332 A1
(43) Pub. Date: Mar. 2, 2023

(54) CONTROLLER FOR AUTONOMOUS AGENTS USING REINFORCEMENT LEARNING WITH CONTROL BARRIER FUNCTIONS TO OVERCOME INACCURATE SAFETY REGION

(71) Applicant: Siemens Aktiengesellschaft, Munich (DE)

(72) Inventors: Ioannis Akrotirianakis, Princeton, NJ (US); Biswadip Dey, Plainsboro, NJ (US); Amit Chakraborty, East Windsor, NJ (US)

(21) Appl. No.: 17/462,648

(22) Filed: Aug. 31, 2021

(51) Int. Cl. B25J 9/16; G06F 17/11; G06F 17/17

(52) U.S. Cl. CPC B25J 9/163; B25J 9/1676; B25J 9/1653; G06F 17/11; G06F 17/17

(57) ABSTRACT

System and method are disclosed for approximating unknown safety constraints during reinforcement learning of an autonomous agent. A controller for directing the autonomous agent includes a reinforcement learning (RL) algorithm configured to define a policy for behavior of the autonomous agent, and a control barrier function (CBF) algorithm configured to calculate a corrected policy that relocates policy states to an edge of a safety region. Iterations of the RL algorithm safely learn an optimal policy where exploration remains within the safety region. CBF algorithm uses standard least squares to derive estimates of coefficients for linear constraints of the safe region. This overcomes inaccurate estimation of safety region constraints caused by one or more noisy observations of constraints received by sensors.

### TECHNICAL FIELD

This application relates to navigation control of autonomous agents. More particularly, this application relates to integrated reinforcement learning-based controller with control barrier function-based controller during exploration of a visually guided autonomous agent.

### BACKGROUND

Navigation controllers for autonomous agents (e.g., vehicles, drones, robots, and the like) have been designed with various machine learning algorithms. Model free reinforcement learning (RL) is an approach that relies on a long-term reward over many iterations using policy gradient methods. A policy defines the behavior of the learning agent at a given time. When defining a policy, perceived states of the environment are mapped to actions to be taken when in those states. Policy gradient methods approximate the gradient of the expected return based on sampled trajectories, and then optimize the policy using gradient ascent and allowing modification in the policy. For example, the Trust Region Policy Optimization (TRPO) algorithm tries to restrict the distribution of the selected policies within a trust region. Despite the effectiveness of RL algorithms based on the TRPO paradigm in learning good quality policies, there is still no guarantee that the computed actions will guide the agent in states that are safe. For example, policy exploration during the training process may cause the test subject to stray into unsafe regions. Without safety guarantees during the learning process, the test subject is at risk for damage before achieving the learned controller. For example, an autonomous agent may deviate from the roadway, or an unmanned aircraft system (e.g., a quadcopter drone) could enter a region with collision hazards, or an expensive robotic arm may hit and injure a human while both work together towards achieving a common task (e.g., moving and installing a heavy metallic bar on a vehicle or an aircraft).

A solution for assisting the learning process for an RL-based controller, including one enhanced by TRPO, is to introduce a control barrier function (CBF) algorithm, which forces RL algorithm states toward an interior of a defined safety region. As shown in FIG. 1, policy 101 is calculated by the RL algorithm, corrected policy 102 is calculated by CBF algorithm, relocating policy states to an edge or the interior of a safety region 110. Further iterations of the RL algorithm safely learn an optimal policy 103, with the CBF algorithm forcing the policy exploration in a direction within the safety region 110.

However, current solutions are deficient regarding how to deal with uncertainty in sensor readings that are used to measure proximity to safety boundaries. For instance, noisy sensor readings may alter the controller's estimation of one or more safety boundaries, which jeopardizes the safety guarantee of the CBF-guided RL algorithm.

### SUMMARY

A system and method are disclosed for approximating unknown safety constraints during reinforcement learning of an autonomous agent. A controller for directing the autonomous agent includes a reinforcement learning (RL) algorithm configured to define a policy for behavior of the autonomous agent, and a control barrier function (CBF) algorithm configured to calculate a corrected policy that relocates policy states to the boundary or the interior of a safety region. Iterations of the RL algorithm safely learn an optimal policy where exploration is forced to remain within the safety region. CBF algorithm uses standard least squares to derive estimates of coefficients for linear constraints of the safe region. This overcomes inaccurate estimation of safety region constraints caused by one or more noisy observations of constraints received by sensors.

### BRIEF DESCRIPTION OF THE DRAWINGS

Non-limiting and non-exhaustive embodiments of the present embodiments are described with reference to the following FIGURES, wherein like reference numerals refer to like elements throughout the drawings unless otherwise specified.

FIG. 1 illustrates an example of a safe policy correction according to a combined reinforcement learning and control barrier function controller.

FIG. 2 shows an example of a computer-based controller for autonomous agents in accordance with embodiments of this disclosure.

FIG. 3 shows a sequence example of an approximation process for unknown safety constraints during reinforcement learning by an autonomous agent controller in accordance with embodiments of this disclosure.

FIG. 4 shows a computing environment within which embodiments of the disclosure may be implemented.

### DETAILED DESCRIPTION

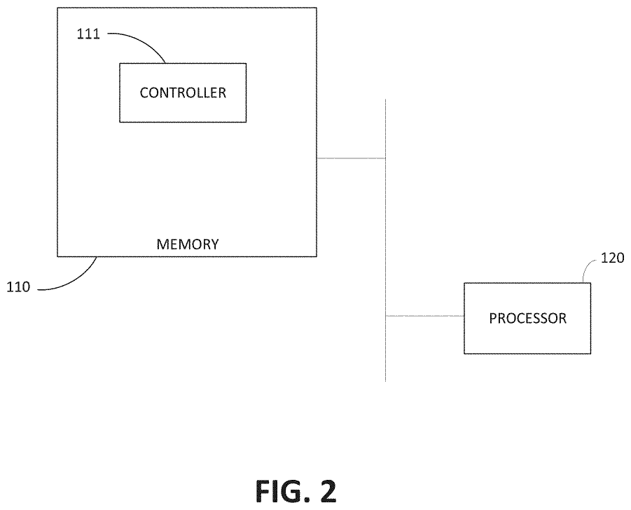

An autonomous agent controller applies a set of algorithms that define policies for behavior of actuators that direct the agent. FIG. 2 shows an example of a computer-based controller 111 stored on memory 110, having multiple algorithms and modules executed by processor 120. A dynamical system can be defined for controller 111 using the following equation:

sₜ₊₁=f(sₜ)+g(sₜ)aₜ+d(sₜ)

where sₜ, aₜ are the state and the action at a specific time point, f, g define the known nominal model dynamics, and d represents unknown model dynamics that can be learned using data (real and/or simulated). Incorporating the control barrier functions (CBF) mechanism within reinforcement learning (RL), the states calculated by RL are pushed towards the interior of the safety region defined by the set:

C={s∈ [symbol] ⁿ:hᵢ(s)≥0,i=1,2, . . . ,m}

where C is defined by the super-level set of m continuously differentiable functions hᵢ: [symbol] ⁿ→ [symbol] . These functions define the constraints that the agent must satisfy at all times in order to ensure its own safety and the safety of its environment. For example, an autonomous vehicle should always maintain a minimum distance from another vehicle that is ahead of it, or an autonomous robot must always reduce its speed when its human coworker is within a specific distance and walks towards the robot. An objective is to ensure that the learning algorithm only explores and learns within set C. In the case of linear constraints, the safety region is defined by a set C forming a polyhedron definable by the following equation:

C={s∈ [symbol] ⁿ:aᵢ^{T}s−bᵢ≥0,i=1,2, . . . ,m}

where aᵢ∈ [symbol] ⁿ is an n-dimensional coefficient vector and bᵢ∈ [symbol] is a scalar. Controller 111 determines the action that always guarantees the states to be within the constrained set C (i.e., safe set) by solving a quadratic programming (QP) problem at every time step of the reinforcement learning process. The objective of the QP problem is to find the right action that does not bring the controlled system to a state that violates the constraints in the safety set C. For this reason, we select the objective of the QP problem to be the Euclidean norm of the vector that represents the possible actions that are available to the agent at the current state, and the constraints will be defined by the inequalities:

h(f(sₜ)+g(sₜ)aₜ+d(sₜ))+(1−η)h(sₜ)≥0,

where the parameter η∈[0, 1] represents how strongly the barrier function “pushes” the state towards the safe set C. The above inequality ensures the new state, which is defined as sₜ₊₁=f(sₜ)+g(sₜ)aₜ+d(sₜ), remains in the safe region. This can be achieved by selecting the appropriate action aₜ so that the above inequality is satisfied.

Gaussian Processes (GP) are used to approximate the function d(s) that defines the unknown model dynamics of the dynamical system. The GP model estimates unknown dynamic function d(s) by calculating the mean μ(s) and variance σ²(s) from measurements obtained using the current state sₜ, the new state sₜ₊₁, and the action aₜ. The estimated dynamics are then expressed by:

\hat{d}(sₜ)=sₜ₊₁−f(sₜ)−g(sₜ)aₜ

In particular, if there are q measurements for the unknown dynamics δ_{q}=[\hat{d}(s₁), \hat{d}(s₂), . . . , \hat{d}(s_{q})], the mean and variance at a new state s₊ can be calculated by using the formulas:

μ(s₊)=k(s₊,s₊)(K+σ²noise I)⁻¹δ_{q}, and

σ⁻²(s₊)=k(s₊,s₊)−k₊^{T}(s₊)(K+σ²noise I)⁻¹k₊(s₊),

where σ²ₙₒᵢₛₑ is the variance of the independent Gaussian noise, and k(⋅, ⋅) is the covariance function, and K is the kernel matrix, and

k₊(s₊)=[k(s₁,s₊), . . . ,k(s_{q},s₊)].

As the training process progresses and more data become available, the variance σ²(s₊), expressing the uncertainty in the dynamical system, will reduce, and the mean μ(s) approximates the unknown dynamics d(s) increasingly more accurately. This process allows the controller 111 to obtain increasingly tight confidence intervals of the unknown dynamics which are defined as |μ(s)−d(s)|≤σ(s). It should be noted that at every iteration of the GP, the m×m kernel matrix K needs to be inverted and therefore the complexity of the GP is O(q³), where q is the number of data points. To achieve constant performance and avoid increasing computational costs in our implementation, the size of the K matrix is set to a fixed number which is equal to the batch size of the training points in the current time step.

In many cases, the constraints describing the Control Barrier Functions may be defined inaccurately or may be unknown a priori when trying to estimate the safety region. This is the case when there is a lot of uncertainty in the model due to noisy measurements defining the coefficients of the constraints (e.g., due to a faulty sensor, or noisy environment interference). Another case arises in robotics when a mobile robot needs to explore an uncertain environment where objects within the environment may dynamically change their positions (e.g., humans walking in close proximity to a robot while they both trying to achieve a common task such lifting or moving a heavy object). In addition, the constraints of the safe region may be learned in an online fashion (e.g., when the autonomous agent needs to navigate in a relatively unexplored terrain during learning) introducing additional risk. A partially known safety region complicates the exploration phase of action selection and may result in states that can be risky and cause physical harm to the autonomous agent. Herein it is assumed that one or more noisy observations of the constraints defining the safe states are accessed, introducing uncertainty for estimating the constraints of the safety region. Embodiments focus on designing efficient algorithms that will guide the autonomous agent towards the safety region and at the same time maximize the expected reward. The proposed approach for controller 111 is to repetitively solve optimization problems whose constraints are increasingly becoming more accurate by collecting measurements of the environment in an iterative fashion. Controller 111 first tries to increase the accuracy by which the unknown constraints are defined, and then optimizes the cumulative discounted rewards within the approximate safe region defined by the approximated constraints.

The controller 111 framework is developed for safety regions defined by linear constraints which can then be extended to more complex nonlinear regions. In the linear case, the safety set is defined by:

G={s∈ [symbol] ⁿ: As−b≥0}

where constraint coefficients A∈ [symbol] ^{q×m} and b∈ [symbol] ^{q} are treated as unknown (i.e., due to the assumed uncertainty of measurements for this analysis) and only accessed via measurements by a simulator or sensors. In particular, the q constraints can be evaluated at points within a hypersphere, B(sₖ, r₀)={s∈S:∥sₖ−s∥≤r₀}, of specific radius r₀ and centered at the current state sₖ. These evaluations could be corrupted by added noise that may follow a certain distribution. Hence, what is received in real time is the noisy constrained set defined as:

G_{∈}={s∈ [symbol] ⁿ:As−b+∈≥0}

for any state s∈B (sₖ, r₀)∩G_{∈}, where ∈ represents sensor measurement corruption. An objective of controller 111 algorithms is to ensure the states sₖ remain within the safe region with sufficiently high probability. At the k-th iteration, the controller 111 calculates p different states sₖ^{j}, j=1, 2, . . . , p, so that each of them is within the hypersphere B(sₖ, r₀) and covers different directions. This can be achieved by sampling p different actions and collecting the resulting states which lie within the hypersphere B(sₖ,r₀). Collecting all the states up to the current time point t provides the different estimates of the unknown constraints. For example, the i-th constraint can be defined as:

cₖⁱ=Sₖaⁱ+bⁱ1+∈

where Sₖ is the matrix that defines the p sampled states that lie within the hypersphere B (sₖ, r₀) and has the following form:

Sₖ=[sₖ¹,sₖ², . . . ,sₖ^{p}]

Cₜ=[cₜ¹,cₜ², . . . ,cₜ^{q}]

where

cₜⁱ=Sₜaⁱ+bⁱ1+∈

and

Sₜ=[sₜ¹,sₜ², . . . ,sₜ^{k×t}]^{T}

Using standard least squares, estimates can be derived for the coefficients Âₜ and \hat{b}ₜ of the linear constraints of the safe region G:

[Âₜ,\hat{b}ₜ]^{T}=[Sₜ^{T}Sₜ]⁻¹Sₜ^{T}Cₜ

Hence, the current approximation of the safe region G can be expressed by:

Ĝₜ={s∈ [symbol] ⁿ:Âₜ−\hat{b}ₜ≤0}

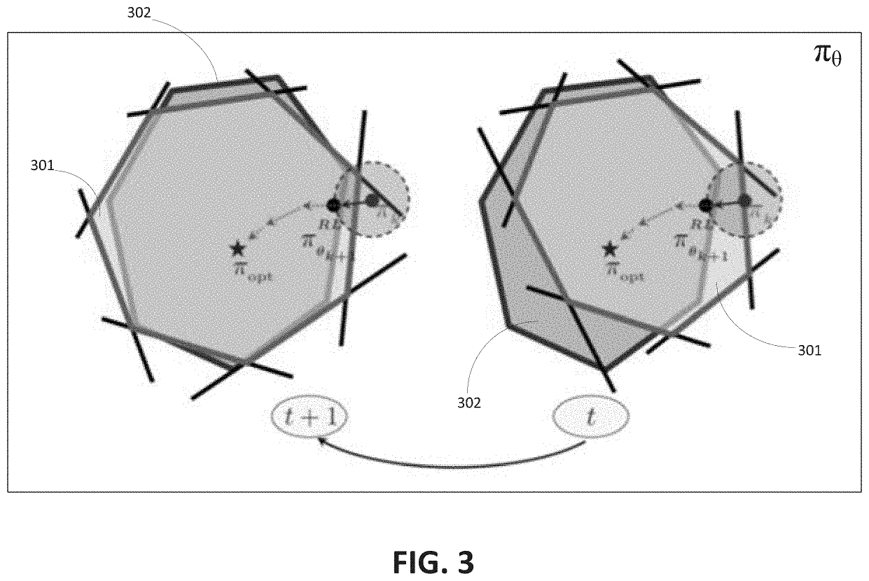

FIG. 3 shows a sequence example of an approximation process for unknown safety constraints during reinforcement learning by an autonomous agent controller in accordance with embodiments of this disclosure. In an embodiment, controller 111 calculates safe policies at various time points using the approximate safe set Ĝₜ. As shown in FIG. 3, at time point t, the estimated feasible region 301 overlaps the true safe region 302. At time point t+1, the estimated safety region 301 is an improved estimation with respect to true safety region 302, compared to the previous time point t. This improvement is achieved by improvement of estimated coefficients Âₜ and \hat{b}ₜ used to derive safe set Ĝₜ.

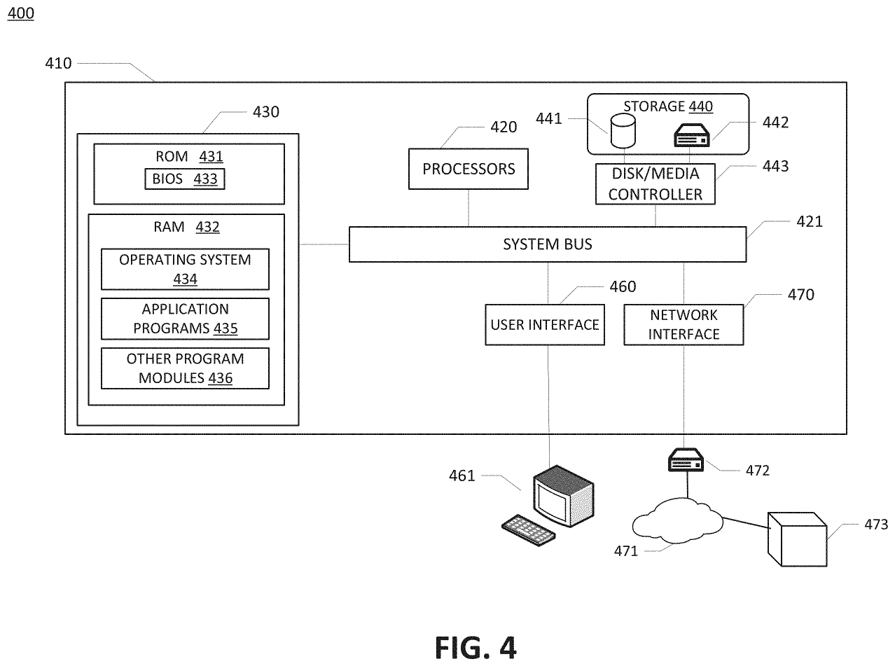

FIG. 4 illustrates an example of a computing environment within which embodiments of the present disclosure may be implemented. A computing environment 400 includes a computer system 410 that may include a communication mechanism such as a system bus 421 or other communication mechanism for communicating information within the computer system 410. The computer system 410 further includes one or more processors 420 coupled with the system bus 421 for processing the information. In an embodiment, computing environment 400 corresponds to a preliminary design validation system, in which the computer system 410 relates to a computer described below in greater detail.

The processors 420 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 420 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 421 may include at least one of a system bus, a memory bus, an address bus, or a message bus, and may permit exchange of information (e.g., data (including computer-executable code), signaling, etc.) between various components of the computer system 410. The system bus 421 may include, without limitation, a memory bus or a memory controller, a peripheral bus, an accelerated graphics port, and so forth. The system bus 421 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

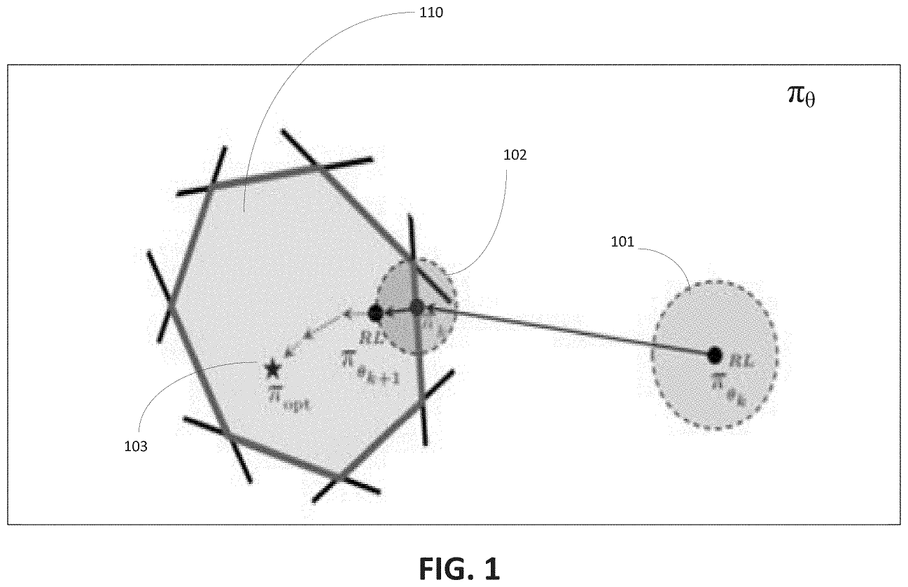

Continuing with reference to FIG. 4, the computer system 410 may also include a system memory 430 coupled to the system bus 421 for storing information and instructions to be executed by processors 420. The system memory 430 may include computer readable storage media in the form of volatile and/or nonvolatile memory, such as read only memory (ROM) 431 and/or random access memory (RAM) 432. The RAM 432 may include other dynamic storage device(s) (e.g., dynamic RAM, static RAM, and synchronous DRAM). The ROM 431 may include other static storage device(s) (e.g., programmable ROM, erasable PROM, and electrically erasable PROM). In addition, the system memory 430 may be used for storing temporary variables or other intermediate information during the execution of instructions by the processors 420. A basic input/output system 433 (BIOS) containing the basic routines that help to transfer information between elements within computer system 410, such as during start-up, may be stored in the ROM 431. RAM 432 may contain data and/or program modules that are immediately accessible to and/or presently being operated on by the processors 420. System memory 430 may additionally include, for example, operating system 434, application modules 435, and other program modules 436. Application modules 435 may include aforementioned modules of controller 111 described for FIG. 1 and may also include a user portal for development of the application program, allowing input parameters to be entered and modified as necessary.

The operating system 434 may be loaded into the memory 430 and may provide an interface between other application software executing on the computer system 410 and hardware resources of the computer system 410. More specifically, the operating system 434 may include a set of computer-executable instructions for managing hardware resources of the computer system 410 and for providing common services to other application programs (e.g., managing memory allocation among various application programs). In certain example embodiments, the operating system 434 may control execution of one or more of the program modules depicted as being stored in the data storage 440. The operating system 434 may include any operating system now known or which may be developed in the future including, but not limited to, any server operating system, any mainframe operating system, or any other proprietary or non-proprietary operating system.

The computer system 410 may also include a disk/media controller 443 coupled to the system bus 421 to control one or more storage devices for storing information and instructions, such as a solid state drive 441 and/or a removable media drive 442 (e.g., flash drive). Storage devices 440 may be added to the computer system 410 using an appropriate device interface (e.g., a small computer system interface (SCSI), integrated device electronics (IDE), Universal Serial Bus (USB), or FireWire). Storage devices 441, 442 may be external to the computer system 410.

The computer system 410 may include a user interface 460 for communication with a graphical user interface (GUI) 461, which may comprise one or more input/output devices, such as a keyboard, touchscreen, tablet and/or a pointing device, for interacting with a computer user and providing information to the processors 420, and a display screen or monitor.

The computer system 410 may perform a portion or all of the processing steps of embodiments of the invention in response to the processors 420 executing one or more sequences of one or more instructions contained in a memory, such as the system memory 430. Such instructions may be read into the system memory 430 from another computer readable medium of storage 440, such as the solid state drive 441 or the removable media drive 442. The solid state drive 441 and/or removable media drive 442 may contain one or more data stores and data files used by embodiments of the present disclosure. The data store 440 may include, but are not limited to, databases (e.g., relational, object-oriented, etc.), file systems, flat files, distributed data stores in which data is stored on more than one node of a computer network, peer-to-peer network data stores, or the like. Data store contents and data files may be encrypted to improve security. The processors 420 may also be employed in a multi-processing arrangement to execute the one or more sequences of instructions contained in system memory 430. In alternative embodiments, hard-wired circuitry may be used in place of or in combination with software instructions. Thus, embodiments are not limited to any specific combination of hardware circuitry and software.

As stated above, the computer system 410 may include at least one computer readable medium or memory for holding instructions programmed according to embodiments of the invention and for containing data structures, tables, records, or other data described herein. The term “computer readable medium” as used herein refers to any medium that participates in providing instructions to the processors 420 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks. Non-limiting examples of volatile media include dynamic memory, such as system memory 430. Non-limiting examples of transmission media include coaxial cables, copper wire, and fiber optics, including the wires that make up the system bus 421. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to illustrations of methods, apparatus (systems), and computer program products according to embodiments of the disclosure. It will be understood that each block of the illustrations, and combinations of blocks in the illustrations, may be implemented by computer readable medium instructions.

The computing environment 400 may further include the computer system 410 operating in a networked environment using logical connections to one or more remote computers, such as remote computing device 473. The network interface 470 may enable communication, for example, with other remote devices 473 or systems and/or the storage devices 441, 442 via the network 471. Remote computing device 473 may be a personal computer (laptop or desktop), a mobile device, a server, a router, a network PC, a peer device or other common network node, and typically includes many or all of the elements described above relative to computer system 410. When used in a networking environment, computer system 410 may include modem 472 for establishing communications over a network 471, such as the Internet. Modem 472 may be connected to system bus 421 via user network interface 470, or via another appropriate mechanism.

Network 471 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 410 and other computers (e.g., remote computing device 473). The network 471 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 471.

It should be appreciated that the program modules, applications, computer-executable instructions, code, or the like depicted in FIG. 4 as being stored in the system memory 430 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 410, the remote device 473, and/or hosted on other computing device(s) accessible via one or more of the network(s) 471, may be provided to support functionality provided by the program modules, applications, or computer-executable code depicted in FIG. 4 and/or additional or alternate functionality. Further, functionality may be modularized differently such that processing described as being supported collectively by the collection of program modules depicted in FIG. 4 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 4 may be implemented, at least partially, in hardware and/or firmware across any number of devices.

It should further be appreciated that the computer system 410 may include alternate and/or additional hardware, software, or firmware components beyond those described or depicted without departing from the scope of the disclosure. More particularly, it should be appreciated that software, firmware, or hardware components depicted as forming part of the computer system 410 are merely illustrative and that some components may not be present or additional components may be provided in various embodiments. While various illustrative program modules have been depicted and described as software modules stored in system memory 430, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

The block diagrams in the Figures illustrate the architecture, functionality, and operation of possible implementations of systems, methods, and computer program products according to various embodiments of the present disclosure. In this regard, each block in the block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams illustration, and combinations of blocks in the block diagrams illustration, can be implemented by special purpose hardware-based systems that perform the specified functions or acts or carry out combinations of special purpose hardware and computer instructions.

What is claimed is:

1. A system for approximating unknown safety constraints during reinforcement learning of an autonomous agent, comprising:
a memory having modules stored thereon; and
a processor for performing executable instructions in the modules stored on the memory, the modules comprising:
a controller configured to direct the autonomous agent according to a dynamical system defined by a current state and an action at a specific time point, wherein a next state is defined by known model dynamics and unknown model dynamics, the controller comprising:
a reinforcement learning (RL) algorithm configured to define a policy for behavior of the autonomous agent; and
a control barrier function (CBF) algorithm configured to calculate a corrected policy that relocates policy states to a boundary of a safety region;
wherein iterations of the RL algorithm safely learn an optimal policy where exploration remains within the safety region;
wherein one or more noisy observations of constraints defining safe states are received by sensors, resulting in inaccurate estimation of safety region constraints; and
wherein the CBF algorithm uses standard least squares to derive estimates of coefficients for linear constraints of the safe region.

2. The system of claim 1, wherein the CBF algorithm defines a safe set C of continuously differentiable functions that define the safety region.

3. The system of claim 2, wherein the continuously differentiable functions for the safety region form a polyhedron having an n-dimensional coefficient vector and a scalar.

4. The system of claim 2, wherein the controller solves a quadratic programming problem at every time step of the reinforcement learning.

5. The system of claim 1, wherein Gaussian processes are used to approximate the unknown model dynamics by calculating mean and variance from measurements obtained using the current state, the next state, and the action.

6. The system of claim 1, wherein the controller is configured to repetitively solve optimization problems whose constraints are increasingly becoming more accurate by collecting measurements of the environment in an iterative fashion, wherein the controller first tries to increase the accuracy by which the unknown constraints are defined, and then optimizes cumulative discounted rewards within the approximate safe region defined by the approximated constraints.

7. A method for approximating unknown safety constraints during reinforcement learning of an autonomous agent, comprising:
directing the autonomous agent according to a dynamical system defined by a current state and an action at a specific time point, wherein a next state is defined by known model dynamics and unknown model dynamics;
using a reinforcement learning (RL) algorithm for defining a policy for behavior of the autonomous agent; and
using a control barrier function (CBF) algorithm for calculating a corrected policy that relocates policy states to a boundary of a safety region;
wherein iterations of the RL algorithm safely learn an optimal policy where exploration remains within the safety region;
wherein one or more noisy observations of constraints defining safe states are received by sensors, resulting in inaccurate estimation of safety region constraints; and
wherein the CBF algorithm uses standard least squares to derive estimates of coefficients for linear constraints of the safe region.

8. The method of claim 7, wherein the CBF algorithm defines a safe set C of continuously differentiable functions that define the safety region.

9. The method of claim 8, wherein the continuously differentiable functions for the safety region form a polyhedron having an n-dimensional coefficient vector and a scalar.

10. The method of claim 8, wherein the controller solves a quadratic programming problem at every time step of the reinforcement learning.

11. The method of claim 7, wherein Gaussian processes are used to approximate the unknown model dynamics by calculating mean and variance from measurements obtained using the current state, the next state, and the action.

12. The method of claim 7, wherein the controller is configured to repetitively solve optimization problems whose constraints are increasingly becoming more accurate by collecting measurements of the environment in an iterative fashion, wherein the controller first tries to increase the accuracy by which the unknown constraints are defined, and then optimizes cumulative discounted rewards within the approximate safe region defined by the approximated constraints.
